(19) United States
(12) Patent Application Publication
(10) Pub. No.: US 2009/0170479 A1
(43) Pub. Date: Jul. 2, 2009

(54) VIRTUAL ROOMS FOR PORTABLE COMMUNICATION DEVICE AND METHOD

(75) Inventor: Pontus JARENSKOG, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/970,022

(22) Filed: Jan. 7, 2008

Related U.S. Application Data
(60) Provisional application No. 61/018,098, filed on Dec. 31, 2007.

(51) Int. Cl. H04M 3/42; H04Q 7/20

(52) U.S. Cl. 455/414.1; 455/418; 455/456.1; 342/357.06

(57) ABSTRACT

A portable electronic device such as a mobile telephone is used with a global satellite navigation system (e.g., GPS) to set up a number of respective profiles that have one or more respective operational settings for the mobile phone, each coordinated with a respective area, such as a home area, an office area, an undefined area, etc. The mobile phone is used with the global satellite system to define a virtual room or area; and during subsequent use of the mobile phone, when it is in a given virtual room or area or is in an undefined area, the mobile phone automatically adjusts to the profile and setting(s) that are coordinated with such area. A virtual room can be defined by positioning the mobile phone at three or more different locations and using a GPS determining virtual boundaries based on signals representing such locations.

### CROSS-REFERENCE TO RELATED APPLICATION

This application claims the benefit of U.S. Provisional Patent Application Ser. No. 61/018,098, filed Dec. 31, 2007, the entire disclosure of which is hereby incorporated by reference.

### TECHNICAL FIELD OF THE INVENTION

The present invention relates generally, as indicated, to virtual rooms for portable communication devices and methods for defining virtual rooms and for using virtual room information to adjust and/or to select automatically profiles and/or settings for portable communication devices, for example, mobile phones, and, more particularly, to mobile phones that change profiles and/or settings based on location determined using information from a global navigation satellite system.

### DESCRIPTION OF THE RELATED ART

Mobile and/or wireless electronic devices are becoming increasingly popular. For example, mobile telephones, portable media players and portable gaming devices are now in wide-spread use as are other portable electronic devices such as, for example, personal digital assistants (PDAs), etc. In addition, the features and accessories associated with certain types of electronic devices have become increasingly diverse. To name a few examples, many portable electronic devices have telephone communications capability, text messaging capability, Internet browsing capability, electronic mail capability, cameras, video playback capability, audio playback capability, image display capability and hands free and wired headset interfaces. Other features of portable electronic equipment include storage and retrieval of contacts, e.g., persons with whom communication may be desired by telephone or text messaging, and their contact information, e.g., telephone number(s), email address, home or business address, etc., and of calendar information.

Many mobile and/or wireless electronic devices include settings and profiles that can be adjusted and determined by the user and/or by the manufacturer. Exemplary settings may be the ring tone that is sounded to signal an incoming telephone call. A user may set different respective ring tones for different callers, e.g., telephone calls from a spouse, child, parent, business colleague, etc. Another exemplary setting is the volume (loudness) of the ring tone, e.g., a user may set the volume to be relatively low in the user's work place, louder in the user's home, and even louder outdoors. Another setting is whether the volume of the ring tone escalates with each ring in a ring sequence. Still other settings may concern whether incoming calls are sent to voice mail, which of several images is shown, for example, as wallpaper, on the display of the electronic device, etc. Other settings may include wireless headset, earphone and/or speaker interconnections, e.g., whether connectible via Bluetooth or other short distance wireless communication and, if affirmative, which connections can be made. Exemplary profiles may include, for example, passwords, carrier selection, etc., the persons who are included in a contacts group, whether and/or which Bluetooth compatible earphones, headsets, and/or speaker(s) are to be coupled with the electronic device, who is permitted to use the portable electronic device (security feature), etc. These are but a few examples of settings and profiles; and it will be appreciated that there currently may be other settings and profiles and still others may come into existence in the future. Also, it will be appreciated that the terms profile and setting sometimes may overlap and/or be used interchangeably.

A user of such portable electronic devices may adjust or select the settings and the profiles of the device when in different places, environments, locations, etc., which may be collectively referred to below as “areas.” For example, in one area, e.g., a user's office, the user may readjust or select the settings and/or profile to turn down the ring tone volume, to direct incoming calls to voice mail if the incoming call is not answered in a prescribed number of rings, to show on the display a conservative wallpaper, to restrict use of the device to only one person, etc. At another area, e.g., at home, the user may readjust or select the settings and/or profile to increase the ring tone volume, to extend the number of rings before directing an incoming call to voice mail, to show on the display a more exotic wallpaper, to allow other family members also to use the device, etc. In the office area a user may set the profile to one group of settings and in the home area the user may set the profile to another group of settings or may change only selected setting(s). In the office area the user may set the portable electronic device to a Bluetooth profile to couple with a particular headset and while outside the office, e.g., in the user's vehicle or home, the user may set the portable electronic device to a different Bluetooth profile to couple with a different earphone, headset, speakers, etc.

Having to make the aforementioned and other adjustments to the settings and/or profiles of a portable electronic device may be inconvenient and also may waste time.

### SUMMARY

An aspect of the present invention relates to a portable electronic device including an input adapted to receive signals representing the location of the electronic device, information storage adapted to store boundaries of a defined area determined by such signals, and a control adapted to determine at least one of a setting or a profile of the portable electronic device based on the current area in which the portable electronic device is located.

According to another aspect, the control is adapted to change at least one of a setting or a profile in response to the device entering the area.

According to another aspect, the control is adapted to change at least one of a setting or a profile in response to the device leaving the area.

According to another aspect, the control is adapted to change at least one of a setting or a profile to a standardized setting or profile in response to the device being moved from within the boundaries of a defined area to an undefined area.

According to another aspect, the control includes an input device actuable by a user of the portable electronic device to apply inputs to establish the boundary of the defined area based on signals received from an external source of electromagnetic energy that represent location of the portable electronic device.

According to another aspect, the portable electronic device is a mobile telephone.

According to another aspect, signals representing location of the portable electronic device are received from a global navigation satellite system.

Another aspect of the invention relates to a method of operating a portable electronic device, including determining whether the portable electronic device is in a predefined area having boundaries defined by a remote electronic system using electromagnetic energy in a locating function, and coordinating at least one profile or setting of the portable electronic device based on the detected predetermined area.

According to another aspect, the coordinating includes automatically selecting at least one profile or setting while the portable electronic device is in the predefined area.

According to another aspect, the coordinating includes changing at least one profile or setting as the portable electronic device is moved from one predefined area either out of that predefined area or into a predefined area.

Another aspect of the invention relates to a method of defining an area for coordinated operation of a portable electronic device, including while the portable electronic device is at a number of different locations determining the respective positions of the portable electronic device using electromagnetic energy signals, and identifying an area based on such positions.

According to another aspect, the determining includes determining using electromagnetic signals.

According to another aspect the respective positions are used to identify a virtual space.

According to another aspect an identifier is provided for different respective areas.

According to another aspect, the method includes coordinating different respective settings or profiles of the portable electronic device with different respective areas by implementing in the portable electronic device the respective coordinated setting or profile while the portable electronic device is in a given area.

According to another aspect, the method includes changing the coordinated setting or profile with regard to entering a respective identified area.

Another aspect of the invention relates to changing the coordinated setting or profile of the portable electronic device upon leaving the respective identified area.

Another aspect of the invention relates to changing at least one coordinated profile or setting of the portable electronic device to or from a basic profile or setting upon entering or leaving an unidentified area.

Another aspect relates to the changing being automatically changing based on the identified or unidentified area.

According to another aspect of the invention the determining includes using signals from a global navigation satellite system.

Another aspect relates to carrying out the various method steps using a portable electronic device that is a mobile telephone.

These and further features of the present invention will be apparent with reference to the following description and accompanying drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment. Also, primed reference numerals may be used to designate the same or similar parts in several of the drawings.

### BRIEF DESCRIPTION OF THE DRAWINGS

FIG. 1 is a schematic illustration of a number of defined areas having respective boundaries in which a portable electronic device may be used in accordance with an embodiment of the invention;

FIG. 2 is a schematic illustration of a portable electronic device in the form of a mobile telephone;

FIG. 3 is a logic diagram illustrating exemplary steps for carrying out an embodiment of the invention;

FIG. 4 is a further logic diagram illustrating exemplary steps for carrying out the invention to adjust or to select respective profiles of a portable electronic device;

FIG. 5 is a logic diagram similar to that of FIG. 4 to adjust or to select respective settings of a portable electronic device; and

FIG. 6 is a schematic block diagram of operating circuitry for a portable electronic device.

### DETAILED DESCRIPTION OF EMBODIMENTS

The present invention will now be described with reference to the drawings, wherein like reference numerals are used to refer to like elements throughout.

The terms “electronic equipment” and “portable electronic device” include portable radio communication equipment. The term “portable radio communication equipment,” which hereinafter may be referred to as a “mobile radio terminal,” includes all equipment such as mobile telephones, pagers, communicators, i.e., electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and use with a mobile telephone and can be and can be used with any type of electronic equipment.

The interchangeable terms “electronic equipment” and “electronic device” include portable radio communication equipment. The term “portable radio communication equipment,” which hereinafter is referred to as a “mobile radio terminal,” as “portable electronic equipment,” as “portable electronic device,” or as a “portable communication device,” includes all equipment such as mobile telephones, pagers, communicators, electronic organizers, personal digital assistants (PDAs), smartphones, portable communication apparatus or the like.

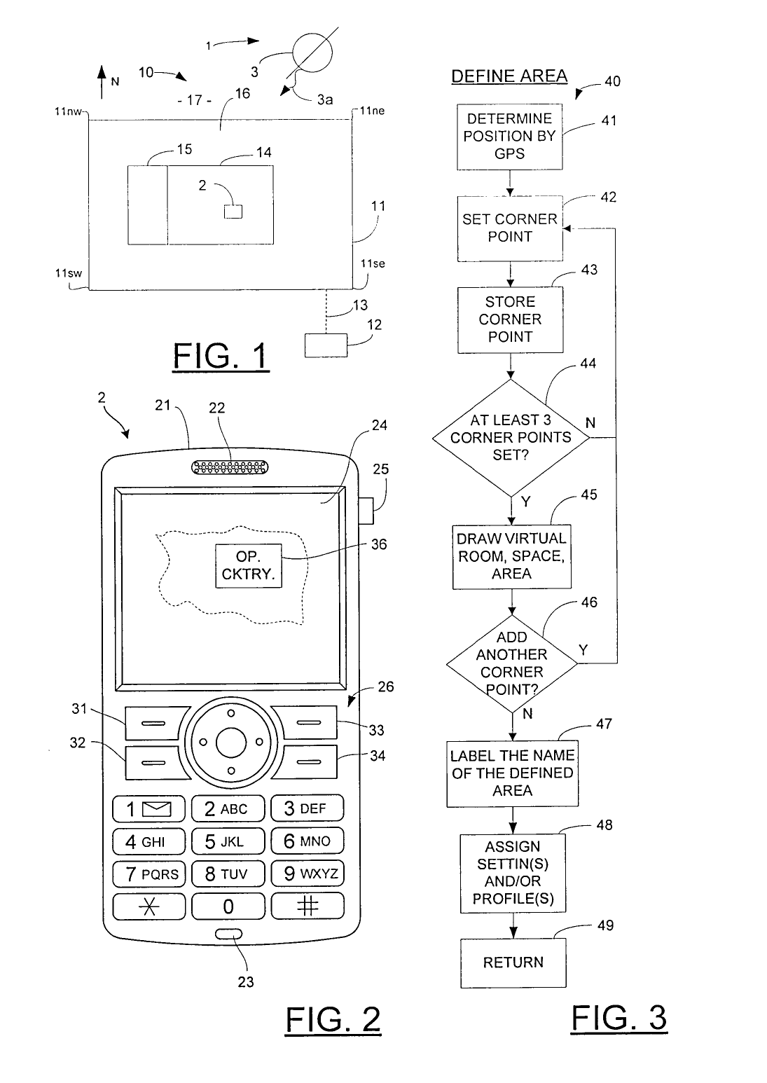

Referring to the drawings, and initially to FIG. 1, using a global satellite navigation system 1, the position (also referred to as location) of a mobile telephone 2 (sometimes referred to as “mobile phone”) can be determined, e.g., latitude, longitude, and, if possible, altitude; and profiles and/or settings of the mobile phone can automatically switch, change, adjust, be selected, etc. based on the position of the mobile phone. In FIG. 1 a single satellite 3 of a global satellite navigation system 1 is illustrated and may represent one or more satellites in space above the Earth as part of a global satellite navigation system, several exemplary types of which are mentioned below. A virtual room or defined area can be defined by positioning the mobile phone 2 at three or more different locations and using a global satellite navigation system to determine those locations, e.g., the respective latitude, longitude and, if possible and desired, altitude thereof, thereby determining the boundaries of the virtual room. Although a minimum of three locations would be needed to define an area of a virtual room, it will be appreciated that the number of such locations or corners may be more than three; also, it will be appreciated that a virtual room can be a custom designed area or space and can be of any size and shape.

Also, in FIG. 1 a number of areas, generally indicated at 10, are represented. Two examples of defined areas within the areas 10 may be a person's home area 11 and the person's office area 12. The office area may be spaced away from the home area, as is represented by the dash line 13. Alternatively, the office area may be part of the home area, e.g., a room in a house 14. The home area 11 may include more specifically defined areas, for example, the house 14, a garage 15 that is attached to or separate from the house, and an outdoor yard 16; and the home area may include other specifically defined areas, such as, for example, respective rooms, the garage 15, etc. Another example of an area 10 is an undefined area 17, which will be discussed further below.

The mobile phone 2 is seen in the area 10, for example, in the house 14. The mobile phone 2 is one example of a portable electronic device in which the invention may be used or with which the invention carried out. It will be appreciated that the invention may be used or carried out with other portable electronic devices, several examples of which are mentioned elsewhere herein. The mobile phone 2 may have a number of functions and capabilities, e.g., initiating and receiving telephone calls, text messaging, email, Internet connection, photograph displaying, music playing, ring tone changing, volume control, etc. The mobile phone 2 may have the capability to adjust and to establish one or more settings and/or profiles, for example, of the type described above and/or others.

A user, e.g., a person who uses the mobile phone 2, such as the owner of the mobile phone, may set up or select respective profiles with respective settings for the mobile phone. For example, the user may set up or select one profile for use in home area 11 and may set up or select respective settings for that profile. The user also may set up or select different settings as part of that same home area profile for different specific parts of the home area, e.g., a relatively quiet ring tone inside the house 14 and relatively louder ring tones in the garage area 15 and yard area 16. The user may set up or select a different profile with respective settings for use in the office area 12. Other profiles and/or settings also may be set up by the user; and some may be set up by the manufacturer of the mobile phone 2, by the carrier company, etc.

The invention provides for automatically determining one or more settings and/or profiles of the mobile phone 2 based on the current area in which the mobile phone is located. The location of the mobile phone 2 may be determined based on inputs, for example, electromagnetic signals 3a, received from one or more satellites 3 of the global satellite navigation system 1. For example, the signals may represent latitude, longitude and, if possible and desired, altitude, of the mobile phone. As the mobile phone 2 is moved from one of the areas 10 to another, the current area is detected, and based on the current area one or more settings and/or profiles of the mobile phone may be changed or adjusted automatically. For example, one or more settings and/or profiles may be determined for use by the mobile phone 2 while the mobile phone is located in the office area 12, one or more different settings and/or profiles may be determined for use while the mobile phone is in the home area 11 or even more specifically, for example, in the house area 14, garage area 15 or yard area 16, and one or more different settings and/or profiles may be determined for use while the mobile phone is in an undefined area 17.

The satellite 3 may be one or several satellites of a global satellite navigation system 1. There currently are a number of different global satellite navigation systems with which the invention may be used, such as, for example, those existing systems known as GPS (Global Positioning System) and as GLONASS (Global'naya Navigatsionnaya Sputnikovaya Sistema), and future systems currently known as Compass (Beidou or Big Dipper), DORIS (Doppler Orbitography and Radio-positioning Integrated by Satellite), Galileo, IRNSS (Indian Regional Navigational Satellite System), QZSS (Quasi-Zenith Satellite System), and GNSS Augmentation. It will be appreciated that the invention may be used with existing and still to be developed space-based location determining systems and also with Earth-based location determining systems.

As an example of using the mobile phone 2, consider that the mobile phone is in the defined area of the house 14. Based on being in the house area, circuitry associated with the mobile phone adjusts or selects one or more settings and/or profiles for the mobile phone, such as, for example, ring tone(s), volume, display wallpaper, contacts who may be called, games that may be played, music that may be played, etc. When a person who uses the mobile phone (the user) takes the mobile phone into the garage area 15 or yard area 16, the change of area and/or the new area is detected by the mobile phone, and it may automatically adjust one or more of the settings and/or profiles. For example, the ring tone volume and/or speaker volume with regard to telephone calls may be increased because it is likely that the ambient sound (noise) in those areas may be louder than that in the ambient environment within the house area 14. In the yard area 16 the brightness of the display of the mobile phone may be increased relative to brightness used indoors, for example, to facilitate seeing images on the display in a bright outdoors environment, e.g., on a sunny day. Thus, profiles and/or settings may switch automatically based on location of the mobile phone 2. When the user is in an undefined area 17, e.g., while traveling between the home area 11 and work area 12, the mobile phone may switch automatically to predetermined standard setting(s) and/or profile(s) that are not associated with a particular defined area. When the user enters the office area 12 from the undefined area 17, the mobile phone may switch automatically to appropriate setting(s) and/or profile(s) for the office, e.g., switching to more conservative wallpaper, reducing ring tone volume, restricting the playing of games and movies, and/or limiting contacts who may be called, or from whom calls may be received without being directed directly to voice mail, turning alarms on or off, etc. The foregoing are only examples of settings and profiles that may be used; there may be others that currently exist or may come into existence in the future.

Referring in further detail to FIG. 2, a portable electronic device, which is a portable communication device in the form of a mobile phone 2 in accordance with an embodiment of the present invention, is illustrated. In outward appearance, for example, as is illustrated in FIG. 2, the mobile phone is of one type of design or style; however, the features of the invention, as are described in further detail herein, may be used in other types of mobile phones, such as those that include cases that open and close (sometimes referred to as a “flip phone” or sliding case phones), and various other mobile phones that currently exist or may come into existence in the future.

The mobile phone 2 includes case (housing) 21, speaker 22, microphone 23, display 24, e.g., liquid crystal display, light emitting diode display, or other display, on/off switch 25, and a number of keys generally indicated at 26. The keys 26 may include a number of keys having different respective functions. For example, the key 30 may be a navigation key, selection key or some other type of key; the keys 31-34 may be, for example, soft switches or soft keys; and the keys 35 may be dialing keys. As an example, the navigation key may be used to scroll through lists shown on the display 24, to select one or more icons or items shown in a list on the display 24, etc. The soft switches 31-34 may be manually operated to carry out respective functions, such as those shown or listed on the display 24 in proximity to the respective soft switch or selected by the navigation key 30, or to carry out designated functions, e.g., a calendar function, an email function, etc. The particular function(s) of the soft switches 31-34 may be determined by the settings or profiles of the mobile phone based on the current area 10 in which the mobile phone is located. The dialing keys 35 may be used to dial a telephone number or to input alphanumeric or other data, e.g., as are illustrated on the respective dialing keys 35. The speaker 22, microphone 23, display 24, and keys 26 may be used and function in the usual ways in which a mobile phone typically is used, e.g. to initiate, to receive and/or to answer telephone calls, to write, to send and to receive text messages, to connect with and to carry out various functions via a network, such as the Internet or some other network, to beam information between mobile phones, etc. These are examples; there may be other uses that currently exist or may exist in the future. The mobile phone 2 also includes operating circuitry 36 that responds to programming and to inputs, e.g., provided by a user pressing a key or applying a stylus or finger to a touch-sensitive screen of the display 24, etc., or provided from an external source, such as an incoming telephone call or text message, to carry out functions of the mobile phone. As is seen in FIG. 2, part of the display 24 and housing 21 of the mobile phone 2 is broken away to show an interior portion of the housing where the operating circuitry 40 of the mobile phone may be located. The operating circuitry 40, which is described further below, may be located elsewhere in the mobile phone, if desired. The operating circuitry alone and/or with other components of the mobile phone 2 may control operation of the mobile phone 2 in response to respective inputs from a user manipulating, e.g., pressing, respective keys 26, externally received inputs, such as a signal representing an incoming telephone call or message, etc. Also, in cooperation and coordination with inputs representing location information received from the satellite 3, e.g., electromagnetic signals received from one or more satellites of a global navigation satellite system, the operating circuitry 40 may set, adjust, determine, etc., one or more respective settings and/or profiles of the mobile phone.

Turning to FIG. 3, an exemplary logic diagram 40 illustrates a method for defining areas, e.g., one or more of the areas 10, in accordance with an embodiment of the present invention. Respective blocks in the drawings represent respective steps or procedures that may be carried out in accordance with the invention. At block 41 the position (also referred to as the location) at which the mobile phone 2 currently is located is determined. In an embodiment of the invention the position is determined by a global navigation satellite system, e.g., a GPS, or by another of the global navigation satellite systems mentioned herein or that may be developed in the future. The position also or alternatively may be determined by a terrestrial navigation system. For brevity, the system that is used to determine the position at which the mobile phone is located will be referred to below as a GPS, although it will be appreciated that other position locating systems, e.g., as mentioned herein, may be used. At block 41 the position of the mobile phone 2 may be determined by electromagnetic energy signals received from a GPS. Use of GPS for position determining purposes is well known and can be found in portable hand-held devices, vehicle mounted devices, etc. The GPS functions may be carried out using the mobile phone in the same or similar manner to the way those functions are carried out in conventional GPS devices. For example, electromagnetic energy signals of an appropriate frequency and wavelength are received by the mobile phone 2 from one or more satellites 3 of the GPS 1 and those signals are appropriately decoded and/or otherwise used to provide position information to the operating circuitry 36, e.g., latitude, longitude, and, if possible and desired, altitude. Thus, the mobile phone 2 may be considered the receiver for those signals in the GPS system. Alternatively, a separate GPS receiver or other device may be used to provide information indicating position of the mobile phone 2 based on signals from the satellite(s).

At block 42 the user of the mobile phone (sometimes referred to as “user”) would set a corner point of an area that that the user intends to define. For example, the yard area 11 in FIG. 1 has four corners 11ne, 11nw, 11se and 11sw, the letters representing, respectively, northeast, northwest, southeast and southwest corners of the yard area, e.g., assuming that the north direction N is toward the top of the drawing. The user may walk to one of the corners, e.g., 11ne, and press one of the keys 26 of the mobile phone 2 providing an input to cause it identify that location as a corner point of the area being defined. At block 43 the information representing the location of such corner point is stored, e.g., in the memory of the mobile phone, such as the memory associated with the operating circuitry 36. The steps at blocks 42 and 43 may be carried out as one step, e.g., when the user reaches the corner point, the user may press a key to receive electromagnetic signals from one or more satellites to represent position information, and based on that pressing of a key, the position information may be stored. Alternatively, the steps at blocks 42 and 43 may be separate steps, whereby, for example, pressing one key causes reading the current position and pressing a second key stores the position information, e.g., in memory.

At block 44 an inquiry is made whether at least three corner points have been set. For example, it takes three points to provide boundaries for an area, e.g., to define an area. If the answer is no, then the steps at blocks 42-44 are repeated until at least three corner points have been set.

If at block 44 at least three corner points were set, then a room, space, area, etc. can be drawn at block 45. Drawing the area may be considered defining or identifying the area as a virtual room, as the area is defined by locations and not necessarily by physical objects at the respective corner points. The boundaries at which the area is drawn and bounded in a sense are virtual boundaries providing a virtual room (or space) that is identified by the mobile phone based on the electromagnetic signals representing position received by the mobile phone, e.g., from one or more satellites of a GPS type global navigation satellite system or from some other position information providing device or system.

At block 46 an inquiry is made whether another corner point is to be set. For example, the further corner point may be the fourth corner of a rectangular area that has right angle sides or it may be a fourth corner of a rectangular area that does not have all right angle sides, e.g., a trapezoid shape area. The further corner point may be a fifth or even higher number corner to cooperate with the other corner points to define an area that is other than a three or four corner area. The determination at block 46 may be carried out by a user pressing a key on the mobile phone to indicate that another corner point is being set; and the operating circuitry 36 may carry out appropriate steps, computations, data storage, etc., to set not only the further corner point but also to place it among other already stored corner points and to draw the boundaries of the virtual room (defined area).

If no further corner points are to be added at block 46, then at block 47 the just defined area is labeled or otherwise identified with a name or other identifier or designation. Such label may facilitate coordinating or assigning one or more respective setting(s) and/or profile(s) to be used by the mobile phone 2 when it is such defined area. At block 48 the setting(s) and/or profile(s) of the mobile phone 2 are assigned to such defined area.

The method steps 40 of FIG. 3 may be carried out as a number of interactive steps by which the user provides inputs to the mobile phone 2, and the satellites, etc. of a GPS provide electromagnetic signals as inputs to the mobile phone 2 representing position information; and the operating circuitry 36 may store the virtual room, e.g., its boundaries, and the setting(s) and/or profile(s) associated with or coordinated with such virtual room. As some of the steps may be carried out in computer program software, logic code, etc., by the operating circuitry 36 or by some other circuitry, a return block 49 is illustrated. At the return block the method routine 40 provide for returning of the computer program, logic code, etc., back to a main routine, etc.

The foregoing exemplary method and equivalents thereof may be used to define areas (also referred to as virtual rooms) at which setting(s) and/or profile(s) for the mobile phone 2 may be desired to be used by the mobile phone. The virtual rooms may be within a building, e.g., a room, garage, etc., may be the entire building, may be a property including one or more buildings and/or outdoor space at which the building(s) are located, etc. One or more setting(s) and/or profile(s) may be assigned to respective virtual rooms. Also, some space may not be defined, e.g., referred to as undefined area. Undefined area may be, for example, an area at which respective boundaries are not drawn by the method 40 or by some other method. An example of an undefined area may be the area of the connection 13 between the home area 11 and the office area 12 (FIG. 1). Such area of connection 13 may be, for example, a commuting distance of several blocks, several miles, or some other distance between the home area 11 and the office area 12. While in undefined areas, the mobile phone 2 may adjust automatically to one or more respective standard setting(s) and/or profile(s) as set by the manufacturer of the mobile phone, by the user, etc.

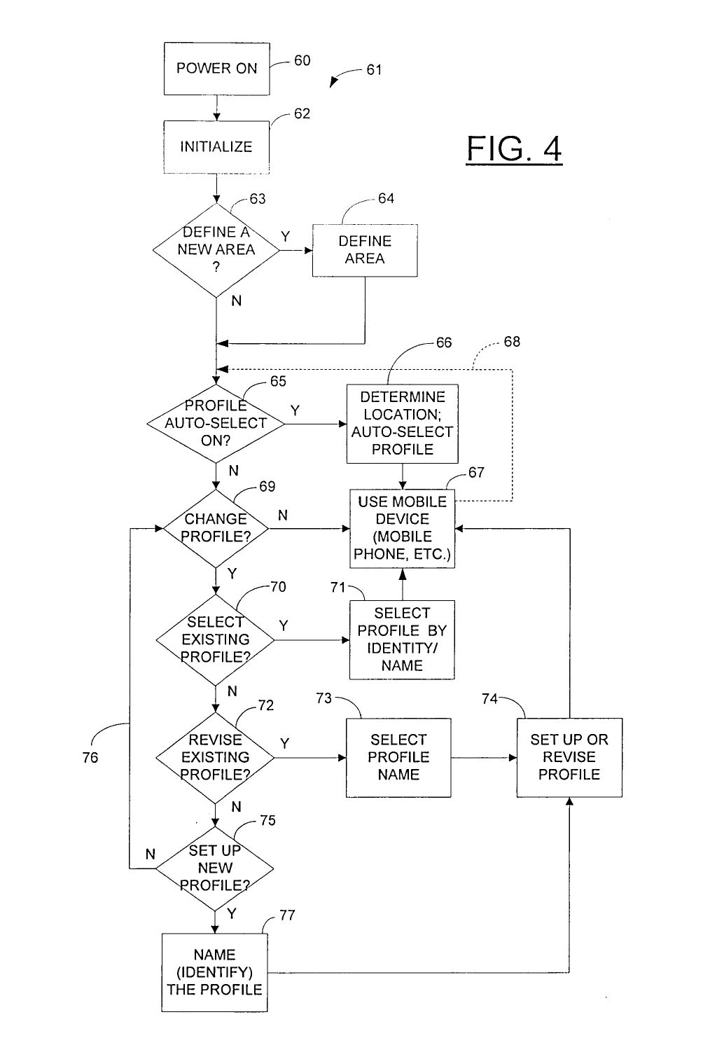

In FIG. 4 an exemplary logic diagram 60 representing an example of a method in accordance with an embodiment of the invention to set up or to revise profile (s) and/or setting (s) of a mobile phone 2 is illustrated. At block 61 the power for the mobile phone 2 is turned on, e.g., on/off switch 25 is switched to the on mode. For example, power would be provided the operating circuitry 36 so that it and the various parts of the mobile phone would be appropriately operational. At block 62 the operational circuitry 36 or other circuitry, program software, etc. is initialized, as is common in electrical and electronic systems. Various settings and/or profiles may be set, e.g., settings and/or profiles that would be used in an undefined area or in use of the mobile phone 2 absent the virtual room detection and automatic setting of setting(s) and/or profile(s) based on the area in which the mobile phone is located.

At block 63 an inquiry is made whether the user desires to define a new area. If yes, then at block 64 the new area is defined, for example, following the method steps described above with respect to the logic diagram 40 of FIG. 3. After the new area has been defined or if the answer at block 63 is no, then at block 65 an inquiry is made whether the profile auto-select function is turned on. The profile auto-select function, if on, allows the mobile phone automatically to determine the current location of the mobile phone, e.g., is it in a defined area and, if so, in which defined area, or is it in an undefined area. Therefore, if the profile auto-select function at block 65 is on, then at block 66 the location of the mobile phone 2 is determined, e.g., using electromagnetic signals from one or more GPS satellites, and the appropriate profile automatically is selected or coordinated for the area in which the mobile phone is located. At block 67 the mobile phone may be used based on the automatically selected profile.

As is represented by a dash loop line 68, the on-off status of the profile auto-select monitor function at block 65 may continue to be checked. Therefore, if the profile auto-select remains on when the mobile phone 2 is moved from one area to another area, block 66 determines the location and automatically selects the profile appropriate to such new area. The new area may be a defined area or an undefined area. If desired, monitoring via loop line 68 may be carried out whenever the mobile phone 2 is used. Such monitoring may be continuous, may be periodic, may be once during each phone call, may be based on an interrupt function caused by some changed condition of the mobile phone, some event, or an input by the user pressing a key, etc.

Returning to block 65, if the profile auto-select function is not on, then at block 69 an inquiry is made to determine whether the current profile is to be changed. If the answer is no, then the mobile phone 2 may be used at block 67 with whatever is the current profile. Loop 68 would continue to be followed, too, to check continually, periodically or upon receiving a user request whether there had been any change in the profile auto-select on-off mode at block 65 or the change profile inquiry at block 69.

If the answer at block 69 is yes, then an inquiry is made at block 70 whether to select an existing profile, e.g., one that had been stored in memory of the mobile phone 2 or one that is standard, e.g., as intended for use at all undefined areas, etc. If the answer at block 70 is yes, then at block 71 the user may select a desired profile by its identity, such as the name of an area, e.g., work area, garage area, yard area, undefined area, etc. Such selection may be carried out by the user pressing one or more keys, entering data on a touch screen of the mobile phone, speaking appropriate words recognized by voice recognition capability in the mobile phone, etc. The mobile phone then may be used, as is indicated at block 67.

If the answer at block 70 is no, then at block 72 an inquiry is made whether to revise an existing profile. If the answer at block 72 is yes, then at block 73 the user may select the profile name, i.e., the name of the profile that is to be revised. At block 74 the identified or named profile would be revised and stored, e.g., in the memory of the mobile phone 2, and then the mobile phone may be used with that profile at block 67.

If at block 72 the answer is no, e.g., the user does not want to revise an existing profile, then at block 75 an inquiry is made whether the user wants to set up a new profile. If the answer is no, then loop 76 is followed back to the change profile inquiry at block 69 or possibly back to the input of the profile auto-select monitor block 65; and the method proceeds as described above.

If at block 75 the answer is yes, a new profile is to be set up, e.g., defined or established, then at block 77 a name or other identity for the new profile is provided, e.g., by the user inputting such name or other identity into the mobile phone 2 via the keyboard, touch sensitive screen, etc. Then, at block 74 the new profile is set up and is provided for use by the mobile phone 2 as it is used at block 67.

The above description of the logic diagram 60 in FIG. 4 is presented with respect to automatically determining location of the mobile phone 2 and automatically selecting (or enabling) the profile for the mobile phone that is to be used when the mobile phone is in such location. It will be appreciated that similar automatic selecting, revising and/or setting up settings for the mobile phone 2 may be accomplished by carrying out steps represented by blocks 65-77, but for settings rather than for profiles. To carry out such method for settings, at each of the blocks 65-77, where the word “profile” appears, it may be understood as replaced by the word “setting” and the above description with regard to blocks 65-77 could be construed as modified to replace the word “profile” by the word “setting.” As another alternative, in the blocks 65-77 and in the above description concerning them, the word “profile” could be replaced by the wording “profile or setting,” thus allowing for both profile and setting to be checked, determined automatically, changed, revised, set up, etc., as was described above with respect to “profile” of the mobile phone 2.

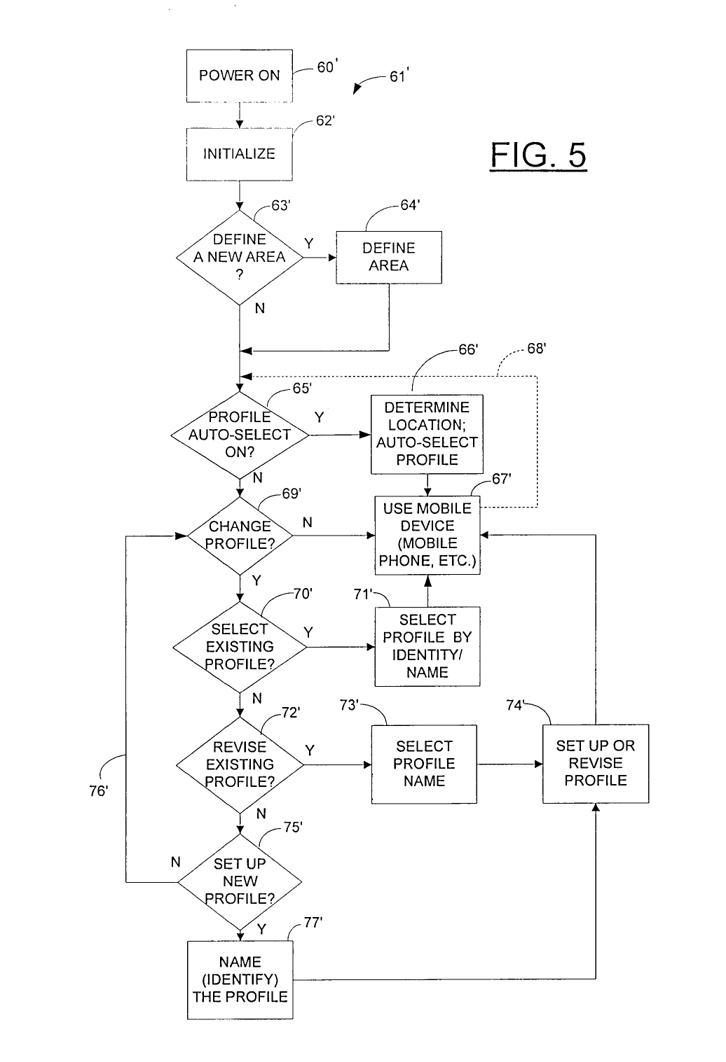

With the above in mind, FIG. 5 is provided as an exemplary logic diagram to illustrate an example of a method 60′ that refers to settings rather than to profiles. The primed reference numerals used in the logic diagram 60′ in FIG. 5 correspond to the unprimed reference numerals of FIG. 4; and the above description pertaining to the profiles in FIG. 4 apply similarly to the settings in FIG. 5. A person who has ordinary skill in the art will appreciate that the description for FIG. 5 and the settings therein will be similar to the above description of FIG. 4 with respect to profiles.

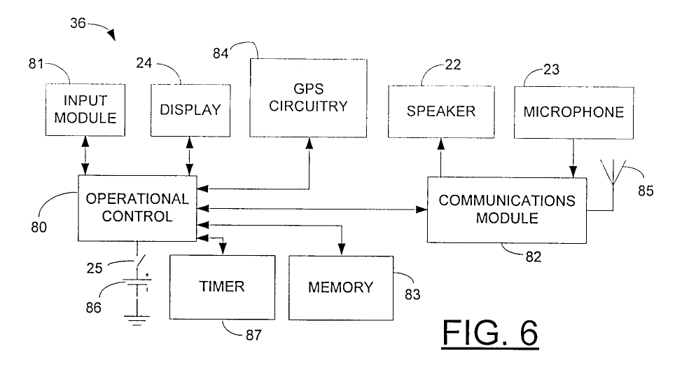

Turning to FIG. 6, a schematic block system diagram of operating circuitry 36 of the mobile phone 2 is illustrated. The illustration is exemplary; other types of circuitry may be employed in addition to or instead of the operating circuitry 36 to carry out the various functions of a mobile phone and the various functions pertaining to defining virtual rooms or areas and automatically selecting and using settings and/or profiles of the mobile phone, etc., as are described in detail herein. The operating circuitry 36 includes an operational control 80 that controls the various components of the operating circuitry. An input module 81 provides inputs to the operational control 80, such as, for example, inputs from the various keys 26. Inputs also may be provided from the display 24 if it is a touch screen type of display, and inputs also may be provided the input module 81 from other connections to the mobile phone, e.g., via wireless or wired connections, etc. The display 24 may be a touch screen that provides for inputs to the input module 81 by touching using a finger, a stylus, or some other device, and the result of such touching may be provided as inputs to the operational control 80. The operational control 80 also may operate the display 24 to determine what information, icons, images, etc. are shown on the display 24. The operating circuitry 36 also may include a communications module 82, e.g., a transceiver, and memory 83, which are coupled to the operational control 80 to provide and to receive voice and data signals, for example, with respect thereto.

GPS circuitry 84 is coupled to the operational control 80. The GPS circuitry 84 may be a GPS receiver that is compatible with a GPS type global navigation satellite system 1 to receive signals from one or more satellites 3 to determine the position or location of the mobile phone 2, as was described above. GPS receivers are known commercial devices that provide such position determining functions. Also, as was mentioned above, the GPS circuitry 84 may be of a type that is compatible with other than a GPS global navigation satellite system, such as those mentioned above and/or others that currently exist or may come into existence in the future. The GPS circuitry 84 may include its own antenna and circuitry to receive signals from one or more satellites and to determine position, e.g., by appropriate signal analysis and/or computation, and may provide the position information as an input to the operational control 80. Alternatively, the GPS circuitry 84 may be coupled to the communications module 82 to use signal receiving functions thereof to obtain signals from the satellite(s), e.g., via antenna 85; and the GPS circuitry may provide the position information to the operational control 80. As still another alternative, the GPS circuitry may be coupled to the operational control 80 and may receive satellite signals via the communications module 82 and the operational control; and based on such signals may determine position of the mobile phone 2.

Electrical power may be provided to the operational control 80 and/or to other portions of the mobile phone 2 by a battery 86 via the on-off switch 25. Program code in the operating circuitry 36, e.g., stored in the memory 83, may control operation of the operational control 80 to operate the various portions of the operating circuitry 36 and, thus, to provide functions of the mobile phone, e.g., as are described above and/or other functions. Circuitry in and/or programming in the operating circuitry 36 and/or operational control 80 may determine various operational features of the mobile phone 2.

As an example, the operational control 80 may be a microprocessor or some other electrical or electronic device that is responsive to various inputs, e.g., input signals, and provides various outputs, e.g., output signals. The operational control 80 may be internally programmed or manufactured in a way to include internal programming thereof to carry out various functions, such as those described above. However, in many instances an operational control 80 of a mobile phone 2 would have associated therewith the memory 83 in which appropriate programming instructions, computer program, logic, etc., may be provided the operational control 80 to carry out the functions thereof. The memory 83 may include identity information concerning profiles of the mobile phone 2 and settings thereof for the operating circuitry 36. The memory 83 also may store information representing locations of corner points mentioned above and, thus, representing the boundaries of respective defined areas (virtual rooms), e.g., based on position information received from the global navigation satellite system 1. As was described above, such profiles and settings may be revised; and a number of different profiles and/or settings may be stored in the memory 83, for example, to carry out the functions described above for automatically adjusting or changing profiles and/or settings with respect to defined areas and undefined areas in which the mobile phone 2 is located. The memory 83 also may include storage for telephone numbers and other information concerning contacts who may be called, messaged, etc. using the mobile phone 2, storage of photographs and/or other data, as often is the capability of such memory in conventional mobile phones, for example, and/or for other purposes that currently exist or may come into existence in the future. The memory 83 may be a read only memory, random access memory (RAM), flash RAM, programmable read only memory, or some other memory device. Also associated with the operational control 80 is a timer 87 that can be used to provide timing signals representing increments of time for synchronizing operation of the operating circuitry 36 with some other device, for use, if necessary, by the GPS circuitry 84 to determine position, for clock/calendar functions, and/or for determining amount of time (duration) for a screensaver function, etc.

The communications module 82 receives inputs from microphone 23 and provides outputs to the speaker 22, as are common functions in a mobile phone. For example, the communications module 82 may be a transceiver typically used in a mobile phone along with appropriate amplifier and other circuitry to provide for the various voice and signal transmission and receiving functions of the mobile phone. The antenna 85 may be coupled to the communications module 82 to transmit and to receive signals representing telephone communications, data communications, messages, etc. The communications module 82 may operate under control of the operational control 80 in the usual manner of a mobile phone. Additionally, the communications module 82 may provide an input to the operational control 80 to indicate that there is an incoming telephone call or text message, e.g., received via antenna 85; and in response thereto, the operational control 80 may operate the display 24 in conventional manner, e.g., to indicate an incoming phone call, to show a text message or photograph, etc.

Operation of the mobile phone 2 may be under computer program control or the like. Such operation may be as is performed to carry out the functions of a mobile phone. Additionally, the functions of setting up respective profiles and/or settings for a mobile phone 2, of defining areas or virtual rooms, of determining position of a mobile phone 2, and of automatically selecting respective profiles and/or settings for respective defined areas as the mobile phone is in a given area or is moved from one area to another, as are described above, also may be carried out under computer program control using the various portions of the operating circuitry 36. The computer programs and computer program control may be prepared or carried out by persons who have ordinary skill in the art to prepare and to use such programs and control. For example, the steps and operations described above, e.g., with respect to FIGS. 3-5, may be carried out using appropriate computer program code that could be written in an appropriate computer programming language by a person who has ordinary skill in the art and such computer program can be stored in memory 83 or otherwise stored, and it can be used to carry out the functions of the mobile phone by the operating circuitry 36. New computer program control techniques and methods also may be developed in the future by persons having ordinary skill in the art and may be used in connection with the connector system and mobile phone and accessories.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A portable electronic device comprising,
an input adapted to receive signals representing the location of the electronic device,
information storage adapted to store boundaries of a defined area determined by such signals, and
a control adapted to determine at least one of a setting or a profile of the portable electronic device based on the current area in which the portable electronic device is located.

2. The portable electronic device of claim 1, wherein the control is adapted to change at least one of a setting or a profile in response to the device entering the area.

3. The portable electronic device of claim 1, wherein the control is adapted to change at least one of a setting or a profile in response to the device leaving the area.

4. The portable electronic device of claim 1, wherein the control is adapted to change at least one of a setting or a profile to a standardized setting or profile in response to the device being moved from within the boundaries of a defined area to an undefined area.

5. The portable electronic device of claim 1, said control comprising an input device actuable by a user of the portable electronic device to apply inputs to establish the boundary of the defined area based on signals received from an external source of electromagnetic energy that represent location of the portable electronic device.

6. The portable electronic device of claim 1, comprising a mobile telephone.

7. The portable electronic device of claim 1, wherein signals representing location of the portable electronic device are received from a global navigation satellite system.

8. A method of operating an portable electronic device, comprising
determining whether the portable electronic device is in a predefined area having boundaries defined by a remote electronic system using electromagnetic energy in a locating function, and
coordinating at least one profile or setting of the portable electronic device based on the detected predetermined area.

9. The method of claim 8, said coordinating comprising automatically selecting at least one profile or setting while the portable electronic device is in the predefined area.

10. The method of claim 8, said coordinating comprising changing at least one profile or setting as the portable electronic device is moved from one predefined area either out of that predefined area or into a predefined area.

11. A method of defining an area for coordinated operation of an portable electronic device, comprising
while the portable electronic device is at a number of different locations determining the respective positions of the portable electronic device using electromagnetic energy signals, and
identifying an area based on such positions.

12. The method of claim 11, said determining comprising determining using electromagnetic signals.

13. The method of claim 11, comprising using the respective positions to identify a virtual space.

14. The method of claim 11, further comprising providing an identifier for different respective areas.

15. The method of claim 11, further comprising coordinating different respective settings or profiles of the portable electronic device with different respective areas by implementing in the portable electronic device the respective coordinated setting or profile while the portable electronic device is in a given area.

16. The method of claim 15, comprising changing the coordinated setting or profile with regard to entering a respective identified area.

17. The method of claim 15, comprising changing the coordinated setting or profile of the portable electronic device upon leaving the respective identified area.

18. The method of claim 16, comprising changing at least one coordinated profile or setting of the portable electronic device to or from a basic profile or setting upon entering or leaving an unidentified area.

19. The method of claim 16, said changing comprising automatically changing based on the identified or unidentified area.

20. The method of claim 8, wherein said determining comprises using signals from a global navigation satellite system.

21. The method of claim 11, wherein said determining comprises using signals from a global navigation satellite system.

22. The method of claim 8, comprising carrying out the method using a portable electronic device that is a mobile telephone.

23. The method of claim 11, comprising carrying out the method using a portable electronic device that is a mobile telephone.
